(19) United States
(12) Patent Application Publication
(10) Pub. No.: US 2016/0112554 A1
(43) Pub. Date: Apr. 21, 2016

(54) MOBILE PHONE, MOBILE TERMINAL, AND VOICE OPERATION METHOD

(71) Applicant: KYOCERA CORPORATION, Kyoto (JP)

(72) Inventor: Tadashi SHINTANI, Osaka (JP)

(21) Appl. No.: 14/983,297

(22) Filed: Dec. 29, 2015

Related U.S. Application Data
(63) Continuation of application No. PCT/JP2014/066983, filed on Jun. 26, 2014.

(30) Foreign Application Priority Data
Jun. 26, 2013 (JP) 2013-133646

(51) Int. Cl. H04M 1/27; H04M 1/67

(52) U.S. Cl. CPC H04M 1/271; H04M 1/67; H04M 2250/74

(57) ABSTRACT

A display, an proximity sensor, and the like are provided in a housing of a mobile phone. For example, when a user brings the mobile phone closer to his/her face with a lock screen being displayed as a predetermined screen, approach of the face may be detected, and a voice recognition function may be executed. In this state, when address data registered is specified and voice instructing calling is input, a telephone function may be specified as a function to be executed, and any address data may be selected from a recognition result. Calling processing may be executed based on a telephone number included in the address data.

### CROSS-REFERENCE TO RELATED APPLICATION

The present application is a continuation based on PCT Application No. PCT/JP2014/066983 filed on Jun. 26, 2014, which claims the benefit of Japanese Application No. 2013-133646, filed on Jun. 26, 2013. PCT Application No. PCT/JP2014/066983 is entitled “Portable Telephone Device, Portable Terminal, and Voice Operation Method”, and Japanese Application No. 2013-133646 is entitled “Mobile Phone, Mobile Terminal, Voice Operation Program, and Voice Operation Method,” and each are incorporated by reference herein in their entireties.

### FIELD

The present disclosure relates to a mobile phone, a mobile terminal, and a voice operation method, and more particularly to a mobile phone, a mobile terminal, and a voice operation method that recognize voice.

### BACKGROUND

With a background art mobile phone, when an operator brings a hand set closer to his/her mouth and an approach switch arranged within the hand set detects approach, a recognition mode of recognizing voice is executed. At this time, if voice similar to previously registered voice is input, a dial signal is sent out based on a telephone number associated with the registered voice. An automatic dialing operation by voice recognition is performed.

### SUMMARY

A mobile phone of an embodiment is a mobile phone having a display module. The mobile phone comprises a detection module, a determination module, a voice recognition module, and a calling module. The detection module is configured to detect approach of a target object. The determination module is configured to determine whether the detection module has detected approach of the target object while a predetermined screen is displayed on the display module. The voice recognition module is configured to, when the determination module determines that approach of the target object has been detected, recognize voice having been input while approach of the target object is detected. The calling module is configured to, when a recognition result of the voice recognition module instructs calling, make a call based on the recognition result.

A voice operation method of an embodiment is a voice operation method in a mobile phone having a display module and a detection module configured to detect approach of a target object. In the voice operation method, a processor of the mobile phone executes a determination step, a voice recognition step, and a calling step. In the determination step, it is determined whether the detection module has detected approach of the target object while a predetermined screen is displayed on the display module. In the voice recognition step, when the determination step determines that approach of the target object has been detected, voice having been input while approach of the target object is detected is recognized. In the calling step, when a recognition result of the voice recognition step instructs calling, a call is made based on the recognition result.

A mobile terminal of an embodiment is a mobile terminal having a display module. The mobile terminal comprises a detection module, a determination module, a voice recognition module, and an execution module. The detection module is configured to detect approach of a target object. The determination module is configured to determine whether the detection module has detected approach of the target object while a predetermined screen is displayed on the display module. The voice recognition module is configured to, when the determination module determines that approach of the target object has been detected, recognize voice having been input while approach of the target object is detected. The execution module is configured to, when a recognition result of the voice recognition module is valid, execute a function based on the recognition result.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is an outline view showing a mobile phone of an embodiment, representing at (A) a main surface of the mobile phone, and at (B) another surface of the mobile phone.

FIG. 2 is an illustration showing an electric configuration of the mobile phone shown in FIG. 1.

FIG. 3 is an illustration showing an example of a lock screen displayed on a display shown in FIG. 1.

FIG. 4 is an illustration showing an example of an operation when canceling a locked state set in the mobile phone shown in FIG. 1, representing at (A) an example in a state where an arc is further displayed on the lock screen shown in FIG. 3, at (B) an example of a direction of a touch operation performed on a lock object shown in FIG. 3, and at (C) an example of a home screen.

FIG. 5 is an illustration showing another example of an operation when canceling the locked state set in the mobile phone shown in FIG. 1, representing at (A) another example of a direction of a touch operation performed on a lock object shown at (A) of FIG. 4, and at (B) an example of a state where a camera function is executed after the locked state is canceled.

FIG. 6 is an illustration showing an example of a state where a screen relevant to a telephone function is displayed on the display shown in FIG. 1, representing at (A) an example of a telephone number input screen, and at (B) an example of an address screen.

FIG. 7 is an illustration showing an example of a state where a screen during calling is displayed on the display shown in FIG. 1.

FIG. 8 is an illustration showing another example of a state where a screen relevant to the telephone function is displayed on the display shown in FIG. 1, representing at (A) another example of the telephone number input screen, and at (B) another example of the address screen.

FIG. 9 is an illustration showing another example of the lock screen displayed on the display shown in FIG. 1.

FIG. 10 is an illustration showing an example of a state where a map function screen is displayed on the display shown in FIG. 1, representing at (A) an example of a map obtained by route search, and at (B) a map of surroundings of a certain facility.

FIG. 11 is an illustration showing an example of a state where a calendar function screen is displayed on the display shown in FIG. 1, representing at (A) an example of a calendar of a certain month, and at (B) an example of a state where a schedule has been registered.

FIG. 12 is an illustration showing an example of a state where a memo pad function screen is displayed on the display shown in FIG. 1.

FIG. 13 is an illustration showing an example of a state where an e-mail function screen is displayed on the display shown in FIG. 1.

FIG. 14 is an illustration showing an example of a state where a browser function screen is displayed on the display shown in FIG. 1.

FIG. 15 is an illustration showing an example of a state where a clock function screen is displayed on the display shown in FIG. 1, representing at (A) a state where a certain time is displayed, and at (B) an example of a state where alarm has been set.

FIG. 16 is an illustration showing an example of a state where a mini blog function screen is displayed on the display shown in FIG. 1.

FIG. 17 is an illustration showing an example of a configuration of a screen ID table stored in a RAM shown in FIG. 2.

FIG. 18 is an illustration showing an example of a memory map in the RAM shown in FIG. 2.

FIG. 19 is a flowchart showing an example of a part of a voice operation process executed by a processor shown in FIG. 2.

FIG. 20 is a flowchart following FIG. 19 showing an example of another part of the voice operation process executed by the processor shown in FIG. 2.

FIG. 21 is a flowchart showing an example of an approach detection process executed by the processor shown in FIG. 2.

### DETAILED DESCRIPTION

When a background art is applied to a mobile phone and with the mobile phone being carried in a bag, an approach switch may malfunction to cause a voice recognition mode to be executed. In this state, an automatic dialing operation may be performed without operator's intention.

Hence, there may be a demand for a novel mobile phone, a novel mobile terminal, and a novel voice operation method. There may be also a demand for a mobile phone and a voice operation method capable of making a call when calling is instructed. There may be also a demand for a mobile terminal capable of reducing malfunctions that would be caused by a voice recognition function.

According to the mobile phone, the voice operation method, and the mobile terminal of an embodiment, a call can be made when calling is instructed.

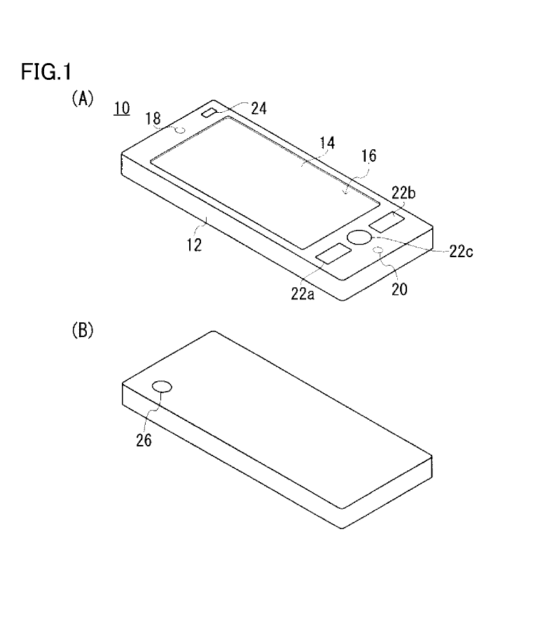

Referring to (A) and (B) of FIG. 1, a mobile phone 10 of an embodiment is a smart phone as an example, and may include a vertically-long flat rectangular housing 12. It is pointed out in advance that the present disclosure is applicable to any mobile terminal, such as a tablet terminal or a PDA.

A crystalline liquid, organic electroluminescence or similar display 14 serving as a display module, for example, may be located on one main surface (front surface) of housing 12. A touch panel 16 may be located on display 14.

A speaker 18 may be built in one end in the longitudinal direction of housing 12 on the main surface side, and a microphone 20 may be built in the other end in the longitudinal direction of housing 12 on the main surface side.

In this embodiment, a call key 22a, a call end key 22b, and a menu key 22c may be located on one main surface of housing 12 as hard keys implementing input operation means together with touch panel 16.

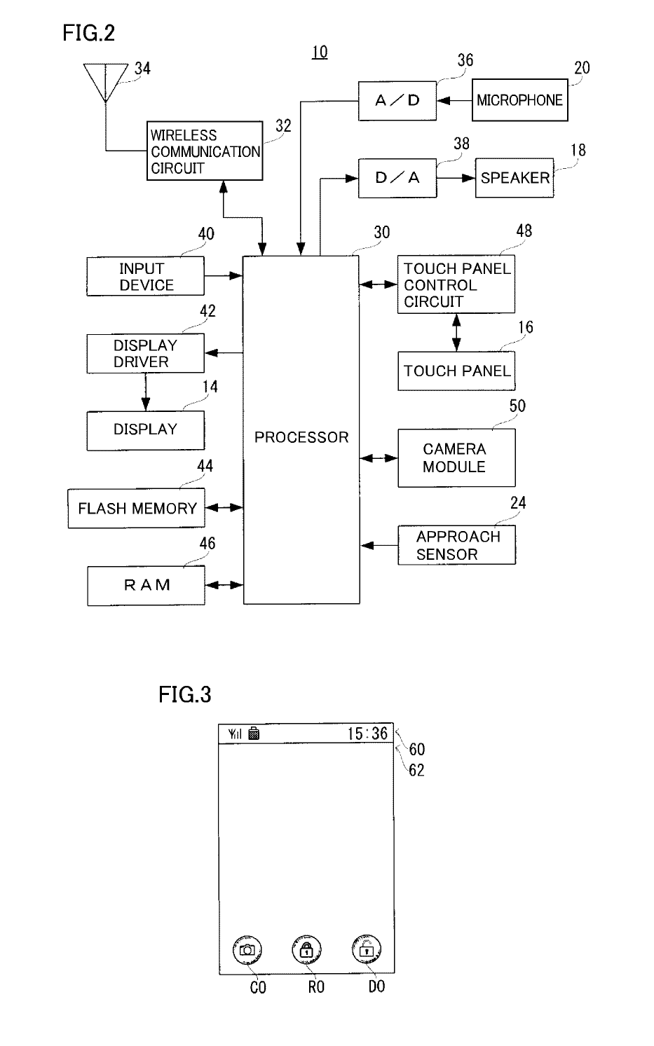

An proximity sensor 24 may be located near speaker 18 on one main surface of housing 12. A lens opening 26 communicating with a camera module 50 (see FIG. 2) may be located at one end in the longitudinal direction on the other surface (rear surface) of housing 12. A sensor surface of proximity sensor 24 and a sensor surface of an image sensor included in camera module 50 can be located so as not to be covered by housing 12, and the remaining portion can be built in housing 12.

For example, a user can input a telephone number by performing a touch operation with touch panel 16 on a dial key displayed on display 14. By operating call key 22a, a user can start a voice call. When call end key 22b is operated, a voice call can be terminated. By pressing and holding call end key 22b, a user can turn on/off mobile phone 10.

When menu key 22c is operated, a menu screen may be displayed on display 14. In this state, by performing a touch operation with touch panel 16 on a soft key, a menu icon, and the like displayed on display 14, a menu can be selected and the selection can be settled.

As detailed description will follow, when a camera function is executed, camera module 50 may be activated, and a preview image (a live view image) corresponding to a field may be displayed on display 14. A user can capture an image of a target object by performing an image capturing operation with the other surface on which lens opening 26 is located being directed toward the target object.

Referring to FIG. 2, mobile phone 10 of an embodiment shown in FIG. 1 includes a computer or a processor 30 called CPU, and the like. Proximity sensor 24, a wireless communication circuit 32, an A/D converter 36, a D/A converter 38, an input device 40, a display driver 42, a flash memory 44, a RAM 46, a touch panel control circuit 48, camera module 50, and the like are connected to processor 30.

Processor 30 can manage overall control of mobile phone 10. All or part of a program previously set in flash memory 44 is developed to RAM 46 in use, and processor 30 can operate in accordance with this program on RAM 46. RAM 46 is further used as a working area or buffer area of processor 30. Flash memory 44 or RAM 46 may also be referred to as a memory module.

Input device 40 includes hard keys 22a to 22c shown in FIG. 1, and thus constitutes an operation receiving module which receives a user's key operation on hard keys 22a to 22c. Information (key data) on a hard key operated by the user may be input to processor 30.

Wireless communication circuit 32 is a circuit for sending/receiving electric waves for a voice call, e-mail, and the like through antenna 34. In an embodiment, wireless communication circuit 32 is a circuit for performing wireless communications in a CDMA system. For example, when a user operates input device 40 to instruct voice transmission (calling), wireless communication circuit 32 can execute voice transmission processing under an instruction from processor 30 to output a voice transmission signal through antenna 34. The voice transmission signal may be sent to a partner's telephone via a base station and a communication network. When reception processing is performed in the partner's telephone, a communication available state is established, and processor 30 can execute call processing.

Microphone 20 shown in FIG. 1 is connected to A/D converter 36. An audio signal from microphone 20 may be input to processor 30 through A/D converter 36 as digital audio data. Speaker 18 may be connected to D/A converter 38. D/A converter 38 can convert digital audio data into an audio signal for supply to speaker 18 through an amplifier. Voice based on the audio data is output through speaker 18.

Display 14 shown in FIG. 1 may be connected to display driver 42, and can display video or an image in accordance with video or image data output from processor 30. Display driver 42 can control the display of display 14 connected to display driver 42 under an instruction from processor 30. Display driver 42 includes a video memory for temporarily storing image data to be displayed. Display 14 may be provided with a back light using LED or the like, for example, as a light source. Display driver 42 can control the brightness and turn-on/off of the back light in accordance with instructions from processor 30.

Touch panel 16 shown in FIG. 1 is connected to touch panel control circuit 48. Touch panel control circuit 48 can apply a required voltage and the like to touch panel 16. Touch panel control circuit 48 can input to processor 30 a touch start signal indicating the start of a touch made by a user on touch panel 16, a termination signal indicating the termination of the touch made by the user, and coordinate data indicating a touch position the user has touched. Processor 30 can determine on which icon or key displayed on display 14 the user has touched, based on this coordinate data.

In an embodiment, touch panel 16 is a capacitance touch panel which detects changes in capacitance occurring between the surface thereof and a target object, such as a finger, having approached the surface. Touch panel 16 can detect that a finger or several fingers has/have touched touch panel 16, for example. Touch panel 16 is also called a pointing device. Touch panel control circuit 48 functions as a touch detection module. Touch panel control circuit 48 can detect a touch operation within a touch effective range of touch panel 16, and can output coordinate data indicating the position of the touch operation to processor 30. A user can perform a touch operation on the surface of touch panel 16, thereby inputting an operation position, an operation direction and the like to mobile phone 10.

The touch operation of an embodiment includes a tap operation, a long tap operation, a flick operation, a sliding operation, and the like.

The tap operation is an operation of contacting (touching) the surface of touch panel 16 with a finger, and then lifting (releasing) the finger from the surface of touch panel 16 after a short period of time. The long tap operation is an operation of continuously contacting the surface of touch panel 16 with a finger for a predetermined time or longer, and then lifting the finger from the surface of touch panel 16. The flick operation is an operation of contacting the surface of touch panel 16 with a finger, and flicking the finger in any direction at a predetermined speed or higher. The sliding operation is an operation of moving a finger in any direction with the finger kept in contact with the surface of touch panel 16, and then lifting the finger from the surface of touch panel 16.

The above-mentioned sliding operation also includes a so-called drag operation, which is a sliding operation of contacting an object displayed on the surface of display 14 with a finger and then moving the object.

In the following description, an operation of lifting a finger from the surface of touch panel 16 after a drag operation will be called a drop operation. A touch operation, a long tap operation, a flick operation, a sliding operation, a drag operation, and a drop operation may each be described with the word “operation” omitted therefrom. An object of an embodiment may include an icon, a shortcut icon, a file, a folder, and the like for executing functions. For the detection scheme of touch panel 16, a resistance film type, an ultrasonic type, an infrared type, an electromagnetic induction type, and the like may be employed instead of the capacitance type described above. A touch operation may be performed not only with a user's finger but also with a stylus pen or the like.

Although not shown, proximity sensor 24 includes a light emitting element (e.g., infrared LED) and a light receiving element (e.g., photodiode). Processor 30 can calculate the distance of a target object (e.g., the user's face) approaching proximity sensor 24 (mobile phone 10) from changes in the output of the photodiode. Specifically, the light emitting element emits infrared light, and the light receiving element receives infrared light reflected by the user's face or the like. For example, when the light receiving element is distant from the user's face, the infrared light emitted from the light emitting element is hardly received by the light receiving element. When the user's face has approached proximity sensor 24, the infrared light emitted by the light emitting element is reflected from the user's face and received by the light receiving element. In this way, the amount of infrared light received by the light receiving element may be varied between the case where proximity sensor 24 has approached the user's face and the case where proximity sensor 24 has not approached the user's face. For example, when proximity sensor 24 has approached the user's face, the amount of received infrared light increases, and when proximity sensor 24 has not approached the user's face, the amount of received infrared light decreases. Proximity sensor 24 may also be referred to as a detection module.

Camera module 50 includes a control circuit, a lens, an image sensor, and the like. When an operation of executing the camera function is performed, processor 30 can activate the control circuit and the image sensor. When image data based on a signal output from the image sensor is input to processor 30, a preview image corresponding to a subject may be displayed on display 14.

Mobile phone 10 of an embodiment can set a locked state where execution of predetermined processing based on a touch operation is restricted in order to prevent a malfunction by user's unintentional input on touch panel 16. For example, when call end key 22b is operated, display 14 and touch panel 16 are turned off, and the locked state is set. When menu key 22c or the like is operated in this state, display 14 and touch panel 16 are turned on, and the lock screen shown in FIG. 3 is displayed, so that an operation of cancelling the locked state becomes acceptable. Also when the display of display 14 does not change for a certain period of time, display 14 may be automatically turned off, and the locked state may be set.

In the locked state of an embodiment, display 14 and touch panel 16 are turned off until the lock screen is displayed, so that power consumption of mobile phone 10 is reduced. In another embodiment, without turning off touch panel 16, a touch operation may be disabled by processor 30 not processing a touch operation as input.

Referring to FIG. 3, the display range of display 14 displaying the lock screen includes a status display region 60 and a function display region 62. In status display region 60, an icon (pictogram) indicating the status of radio wave reception by antenna 34, an icon indicating the remaining capacity of a secondary battery, and the time may be displayed. In function display region 62, a current date 60 may be displayed, and a lock object RO, a cancel object DO, and a camera object CO may be displayed at the lower side.

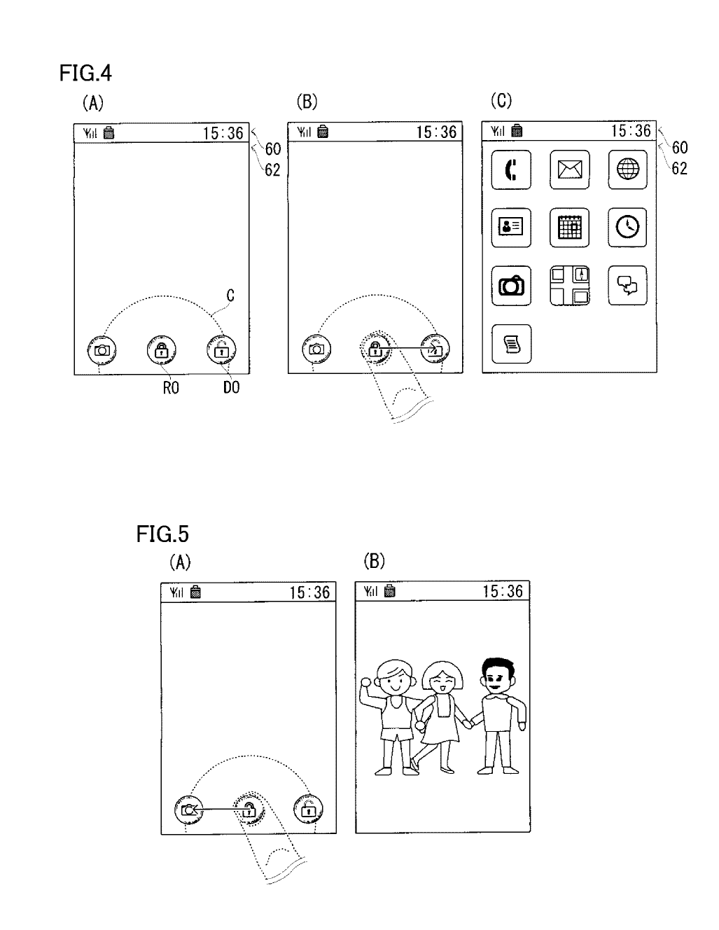

Referring to (A) of FIG. 4, when lock object RO is touched, an arc C may be displayed such that cancel object DO and camera object CO are arranged on its orbit. When lock object RO is dragged, the display position thereof may change in accordance with the position of a user's finger, namely, a current touch position.

Referring to (B) of FIG. 4, when lock object RO is dragged and then dropped while being overlaid on cancel object DO, the locked state may be canceled. When the locked state is canceled, a home screen may be displayed in replacement of the lock screen, as shown at (C) of FIG. 4. A user can cancel the locked state by dragging lock object RO and dropping it on cancel object DO.

Since lock object RO and cancel object DO are displayed at the lower side of display 14, a user can easily perform with one hand the operation of cancelling the locked state using lock object RO. A user can perform the operation of cancelling the locked state either by the right or left hand.

When dropping lock object RO on cancel object DO, lock object RO may be overlaid on release object DO either partially or entirely. The locked state is canceled by dropping lock object RO in either state.

Referring to (A) of FIG. 5, when lock object RO is dragged and dropped on camera object CO displayed on display 14, the locked state is canceled, and the camera function may be executed. When the camera function is executed, a live view image obtained by the camera function may be displayed on display 14 in replacement of the lock screen, as shown at (B) of FIG. 5. A user can cancel the locked state and can execute the camera function.

On the home screen (FIG. 4(C)) described above, a plurality of functional objects corresponding to the telephone function, e-mail function, browser function, calendar function, clock function, camera function, map function, mini blog function, and memo pad function are arranged. A user can execute any function by performing a touch operation on any functional object among these functional objects.

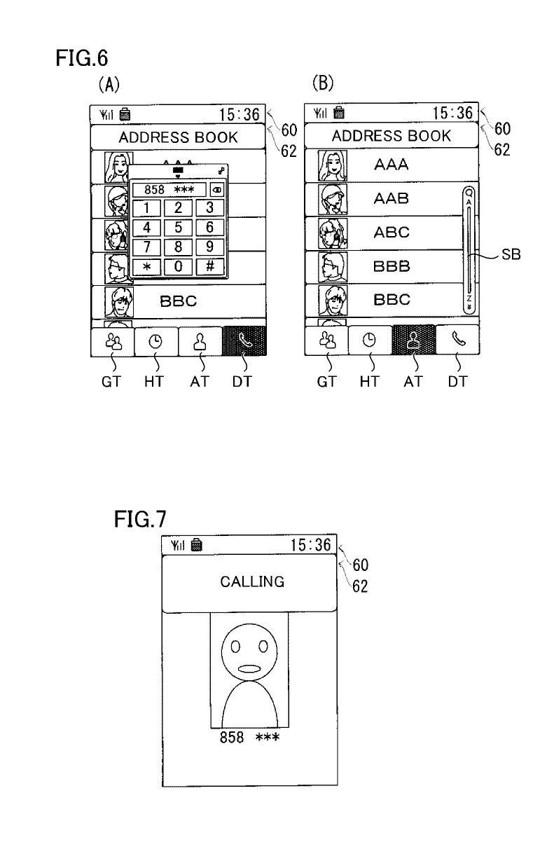

FIG. 6 shows at (A) an example of a telephone number input screen displayed as a screen relevant to the telephone function. For example, when the functional object corresponding to the telephone function (telephone object) is touched, the telephone number input screen may be displayed. On this screen, address data included in an address book and a plurality of tabs may be displayed, and a dial pad for performing calling may be displayed.

The address data contains names, telephone numbers and the like registered by a user, and on the telephone number input screen, a plurality of pieces of address data may be displayed as an “address book.” The plurality of tabs include a group switching tab GT for switching the address book from the character order (the alphabetical order or the like) to the order of groups set by a user, a history tab HT for displaying calling/call reception histories, an address book tab AT for displaying the address book, and a dial tab DT for direct input of a telephone number to perform calling. In the state shown at (A) of FIG. 6, dial tab DT has been selected, and the color of dial tab DT has been reversed.

The dial pad includes a dial key group for inputting a telephone number, a correction key for correcting the input telephone number, and the like.

FIG. 6 shows at (B) an example of an address screen displayed as a screen relevant to the telephone function. For example, the address screen may be displayed when address book AT tab is operated or a functional object for displaying the address book (address book object) is touched. On this address screen, address data may be displayed in a selectable manner. A search bar SB may be displayed on the right side of function display region 62. For example, when a user touches search bar SB, address data may be displayed based on a character (e.g., A, B, C, . . . ) corresponding to the touch position. When a user slides his/her finger up and down on search bar SB, the character corresponding to the touch position changes, so that address data displayed may also change. A user can efficiently search necessary address data from the address book by utilizing search bar SB. A user can select any address data to thereby make a call to a partner's telephone corresponding to the address data.

FIG. 7 is an illustration showing an example of a screen during voice calling. For example, when call key 22a is operated after a telephone number is input on the dial pad, the screen during calling may be displayed in function display region 62. On the screen during calling, a message and an image indicating that calling is being performed may be displayed. By operating call end key 22b before a talking state with a partner is established, a user can interrupt voice transmission processing. When the voice transmission processing is interrupted, an immediately preceding screen, for example, the telephone function screen shown at (A) of FIG. 6 is displayed.

Mobile phone 10 has a voice recognition function, and the function of mobile phone 10 may be executed based on a recognition result. A user can operate mobile phone 10 with voice (voice operation). However, when the voice recognition function is executed all the time, some function may be executed without user's intention due to surrounding noise. With the voice recognition function being executed all the time, power consumption will be disadvantageously increased. In an embodiment, by limiting the state where the voice recognition function is executed, malfunctions that would be caused by a voice operation can be reduced, and power consumption can be reduced.

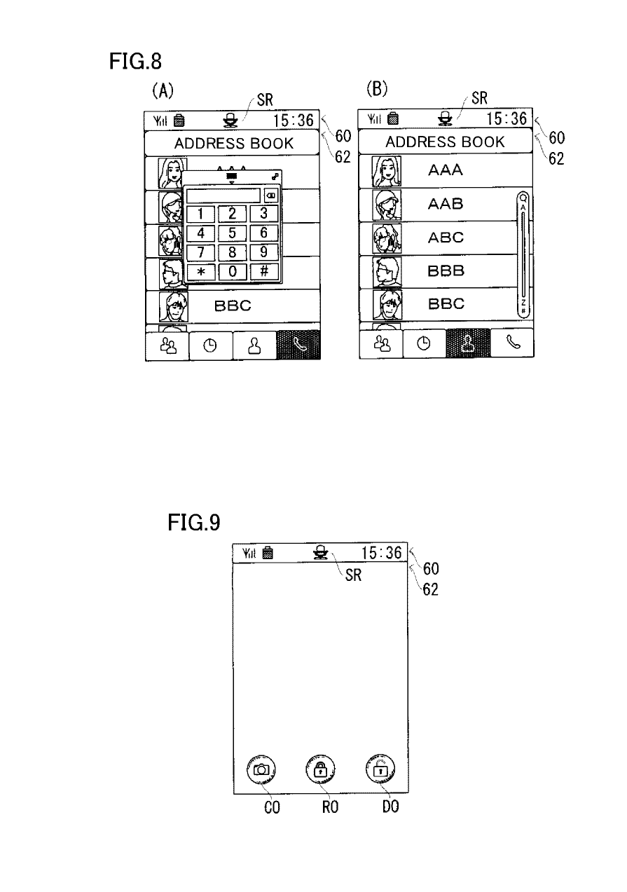

In an embodiment, when a predetermined screen is displayed on display 14 and approach of the user's face is detected, the voice recognition function may be executed. Referring to (A) of FIG. 8, when proximity sensor 24 detects approach of the user's face with the telephone number input screen being displayed, the voice recognition function may be executed. A voice recognition icon SR may be displayed on status display region 60 substantially at the same time when the voice recognition function is executed. When a user utters voice indicating a number (e.g., 1, 2, 3, . . . ) in this state, that voice may be recognized. Numbers indicated by the recognition result are input as a telephone number, and a call is made to that telephone number. When voice indicating a number of predetermined digits is recognized or when voice saying “calling” is recognized while voice recognition is executed, a call may be made.

Referring to (B) of FIG. 8, in the case where the address screen is displayed, voice recognition icon SR may also be displayed when the voice recognition function is executed by approach of the user's face. At this time, when voice indicating address data is uttered, that voice may be recognized, and a call may be made based on address data indicated by the recognition result. If a screen relevant to the telephone function is displayed, a user can easily make a call.

A telephone number may be input by voice on the address screen, or a word specifying address data may be input by voice on the telephone number input screen.

Referring to FIG. 9, also when the user's face is brought closer to the mobile phone with the lock screen being displayed, voice recognition icon SR may be displayed, and the voice recognition function may be executed. In this state, by inputting by voice a word or telephone number specifying address data and a word indicating the telephone function (e.g., “calling” etc.), a user can make a call to any person. A user can make a call without canceling the locked state.

In an embodiment, the address screen or the telephone number input screen relevant to the telephone function and the lock screen or the like serve as predetermined screens, and when a user brings his/her face closer to the mobile phone with these predetermined screens being displayed on display 14 and instructs calling, a call can be made. In particular, since calling is instructed with the user's face brought closer to the mobile phone, the user can start a conversation naturally.

Since the state where the voice recognition function is executed is limited, power consumption of mobile phone 10 is reduced.

A user can make a call only by uttering a word or telephone number specifying registered address data.

When proximity sensor 24 detects approach of the user's face or the like, a touch operation on touch panel 16 is disabled. A malfunction that would be caused by the user's face or the like touching touch panel 16 is prevented from occurring.

On the lock screen in which the voice recognition function is executed, a function other than the telephone function can also be executed by a voice operation by inputting by voice a word specifying a function and details of an operation.

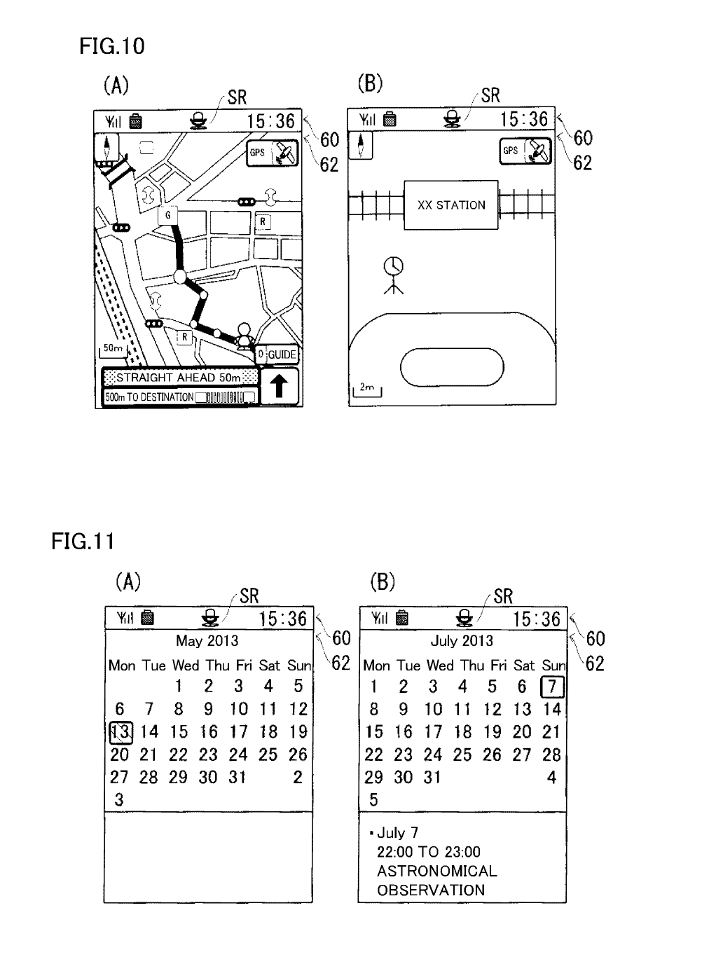

Referring to (A) of FIG. 10, when “a route to a XX station” is input by voice on the lock screen, the “route” included in the recognition result indicates the map function, also indicates use of route search of the map function. When such voice input is performed, the map function is executed, and a route from a current position to the “XX station” is searched. A route as a search result and a map of surroundings of the route may be displayed on display 14.

Referring to (B) of FIG. 10, when “a map of surroundings of the XX station” is input by voice on the lock screen, the “map of surroundings” included in the recognition result indicates the map function, and also indicates use of facility search. When such voice input is performed, the map function is executed, and the position of the “XX station” on the map is searched. The map of surroundings of the “XX station” may be displayed on display 14 as a search result.

Since a map function screen of the map function is also included in the predetermined screen, if “a route to the XX station” is input by voice on the map function screen, a route to the destination may be displayed, and if the “XX station” is input by voice, the map of surroundings may be displayed.

Referring to (A) of FIG. 11, when a “calendar” is input by voice on the lock screen, a “calendar” included in the recognition result indicates the calendar function. The calendar function is executed, and a calendar including the date on which the operation is being performed may be displayed on the display.

Referring to (B) of FIG. 11, when “register astronomical observation on July 7 in schedule” is input by voice on the lock screen, “schedule registration” included in the recognition result indicates the calendar function, and also indicates schedule registration. “July 7” included in the recognition result indicates the date for which schedule registration is performed. Therefore, “astronomical observation” may be registered on “July 7” as details of the schedule.

If the calendar screen of the calendar function is set as a predetermined screen and “astronomical observation on July 7” is input by voice, “astronomical observation” may be added to the schedule of “July 7”.

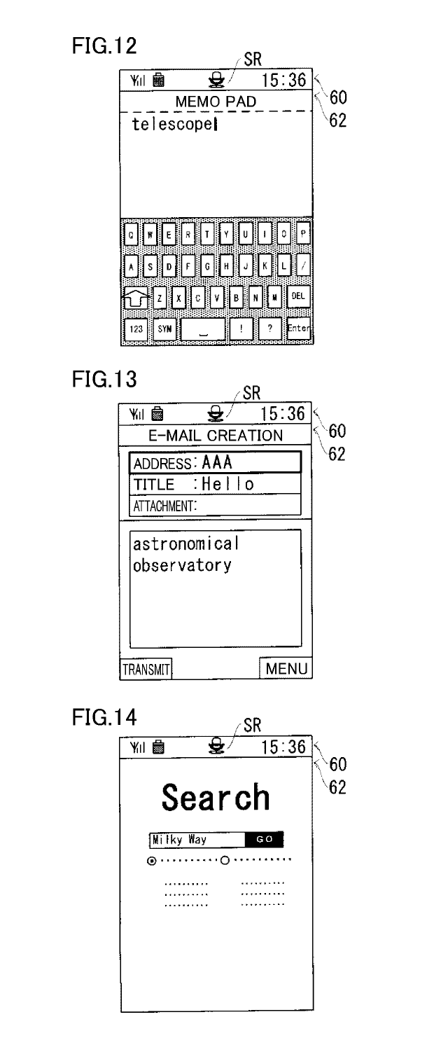

Referring to FIG. 12, when “register telescope in a memo pad” is input by voice on the lock screen, a “memo pad” included in the recognition result indicates the memo pad function. After the memo pad function is executed, the state where “telescope” included in the recognition result has been input is brought about. When “telescope” is input by voice with the memo pad function being executed, characters can be input by voice.

Referring to FIG. 13, when “e-mail to AAA” is input by voice on the lock screen, “e-mail” included in the recognition result indicates the e-mail function, and also indicates creation of a new e-mail message. “AAA” included in the recognition result is a word indicating address data. The e-mail function is executed, and an edit screen of a new e-mail message addressed to AAA may be displayed on display 14. Also when “e-mail to AAA” is input by voice with the e-mail function being executed, edit of a new e-mail message addressed to AAA may be displayed.

Referring to FIG. 14, when “search for Milky Way over a network” is input by voice on the lock screen, “search over a network” included in the recognition result indicates the browser function, and also indicates querying a search engine or the like. After the browser function is executed, “Milky Way” may be searched using a search engine or the like. When “Milky Way” is input by voice with the browser function being executed, the character string of the recognition result may be searched on a search engine.

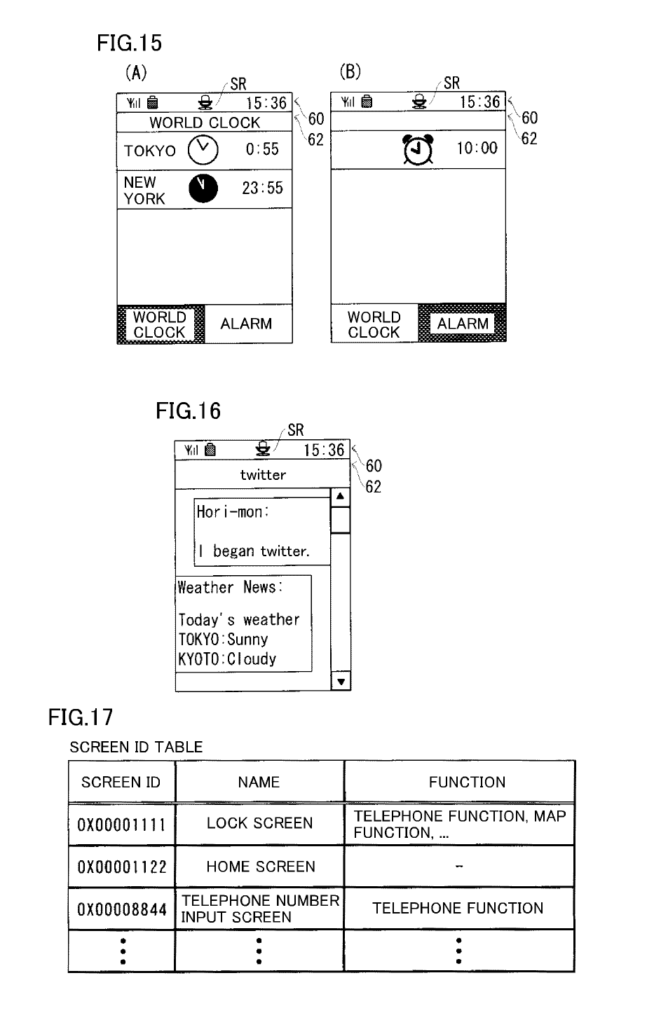

Referring to (A) of FIG. 15, when “current time” is input by voice on the lock screen, the “current time” included in the recognition result indicates the clock function. The clock function is executed, and the current time may be displayed on display 14.

Referring to (B) of FIG. 15, when “alarm at 10:00” is input by voice on the lock screen, the “alarm” included in the recognition result indicates the clock function, and also indicates registration of alarm. After the clock function is executed, alarm is registered at “10:00”, and the alarm screen may be displayed on display 14.

Also when “alarm at 10:00” is input by voice with the clock screen of the clock function serving as a predetermined screen, alarm may be registered at “10:00”.

Referring to FIG. 16, when “tweet that I began twitter” is input by voice on the lock screen, “tweet” included in the recognition result indicates the mini blog function, and also indicates posting of a new article. The mini blog function is executed, and the character string of “I began twitter” may be posted to a mini blog. Also when “I began twitter” is input by voice with a site of a mini blog being displayed by the mini blog function, the character string of “I began twitter” may be posted to the mini blog.

As understood from these examples, a user can execute any function by a voice operation without performing the operation of cancelling the lock screen.

Since the voice recognition function is executed when a face is brought closer to a mobile phone on the lock screen, malfunctions that would be caused by the voice recognition function can be reduced.

FIG. 17 shows an example of a configuration of a screen ID table. To each screen displayed on display 14, a screen ID for identifying each is assigned. The screen ID table includes columns of screen ID, name and function. In the column of screen ID, screen IDs (e.g., 0X00008844 etc.) are stored. In the column of name, names of screens (e.g., telephone number input screen etc.) are stored in association with the screen IDs. In the column of function, functions (e.g., telephone function etc.) are stored in association with the screen IDs. Each row of the screen ID table may also be referred to as functional information.

In an embodiment, a function to be executed is associated with a screen ID of a predetermined screen. When a predetermined screen other than the lock screen is displayed, the function corresponding to the predetermined screen can be executed even if a word specifying the function has not been input.

In this way, even with some function being executed, a user can operate that function by a voice operation.

It is needless to say that the words indicating respective functions are not limited to “route”, “calendar” and the like, but other words may also be used.

When “photography” is input by voice on the lock screen, the camera function is executed, and a live view image as shown at (B) of FIG. 5 may be displayed on display 14.

In another embodiment, it may be set such that a recognition result is displayed on display 14, and unless a user performs a confirmation operation, a next operation is not executed.

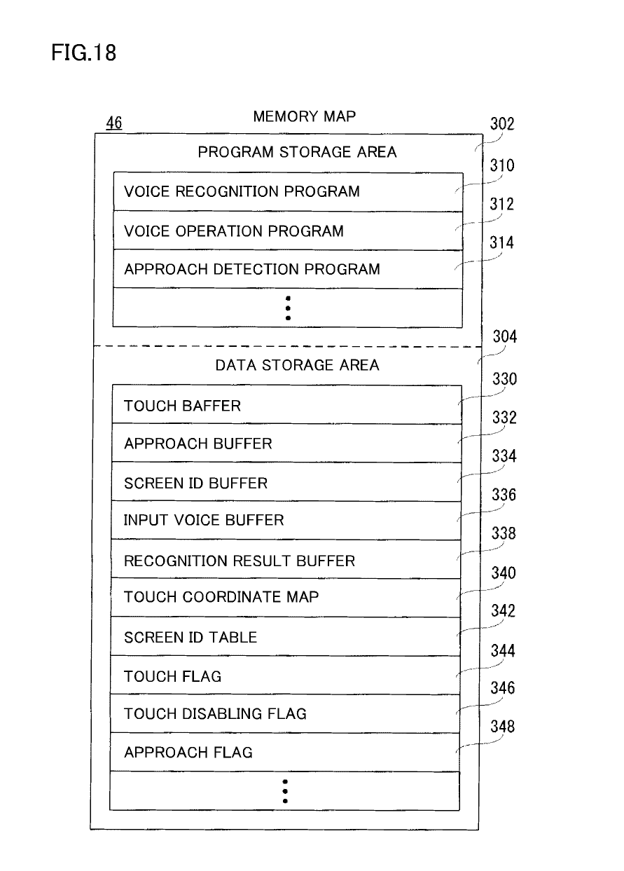

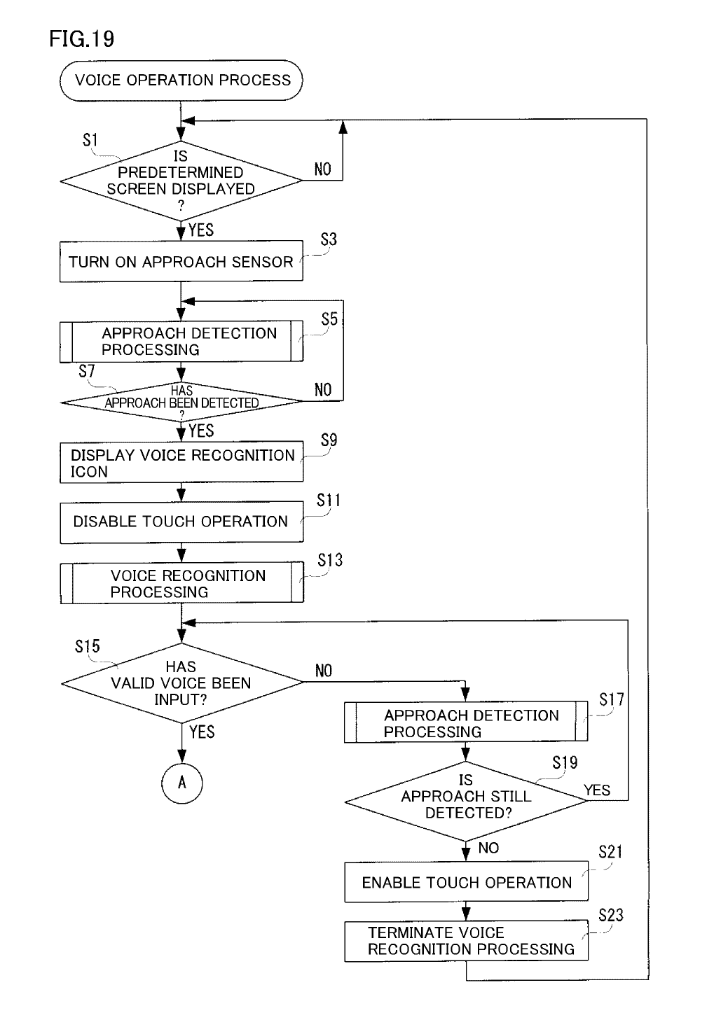

The features of an embodiment have been described above briefly. Hereinafter, detailed descriptions will be given using the memory map shown in FIG. 18 and the flowcharts shown in FIGS. 19 to 21.

Referring to FIG. 18, a program storage area 302 and a data storage area 304 are formed in RAM 46 shown in FIG. 2. Program storage area 302 is an area where some or all pieces of program data previously set in flash memory 44 (FIG. 2) are read and stored (developed), as described earlier.

Program storage area 302 stores a voice recognition program 310 for recognizing voice, a voice operation program 312 for performing a voice operation, an approach detection program 314 for detecting approach of a target object by proximity sensor 24, and the like. Program storage area 302 also includes programs for executing the telephone function, the e-mail function, and the like.

Data storage area 304 of RAM 46 is provided with a touch buffer 330, an approach buffer 332, a screen ID buffer 334, an input voice buffer 336, a recognition result buffer 338, and the like, and stores a touch coordinate map 340, a screen ID table 342, and the like. Data storage area 304 is also provided with a touch flag 344, a touch disabling flag 346, an approach flag 348, and the like.

Touch buffer 330 may temporarily store data of touch coordinates output from touch panel control circuit 48. Approach buffer 332 may temporarily store output from proximity sensor 24. Screen ID buffer 334 may temporarily store screen ID of a screen being displayed. Input voice buffer 336 may temporarily store audio data of voice input by a user. Recognition result buffer 338 may temporarily store a recognition result (character string) obtained by voice recognition processing.

Touch coordinate map 340 is data for associating the touch coordinates in a touch operation with the display coordinates on display 14. Based on touch coordinate map 340, the result of a touch operation performed on touch panel 16 may be reflected in the display of display 14. Screen ID table 342 is a table in which each function is stored in association with a screen ID as shown in FIG. 17, for example.

Touch flag 344 is a flag for determining whether or not touch panel 16 has been touched. For example, touch flag 344 is implemented by a 1-bit register. When touch flag 344 is turned on (established), a data value “1” is set in the register. On the other hand, touch flag 344 is turned off (not established), a data value “0” is set in the register. On/off of touch flag 344 may be switched based on a signal output from touch panel control circuit 48.

Touch disabling flag 346 is a flag indicating whether a touch operation on touch panel 16 has been disabled. For example, if touch disabling flag 346 is off, a touch operation has been enabled, and if touch disabling flag 346 is on, a touch operation has been disabled. Approach flag 348 is a flag indicating whether proximity sensor 24 has detected approach of a target object. For example, if approach flag 348 is on, proximity sensor 24 has detected approach of a target object, and if approach flag 348 is off, proximity sensor 24 has not detected approach of a target object.

Data storage area 304 stores image data displayed in the standby state, data of character strings, and the like, and is also provided with a counter and flags necessary for operating mobile phone 10.

Flash memory 44 may store a table in which a word indicating a function is associated with the function, address data, and dictionary data for voice recognition.

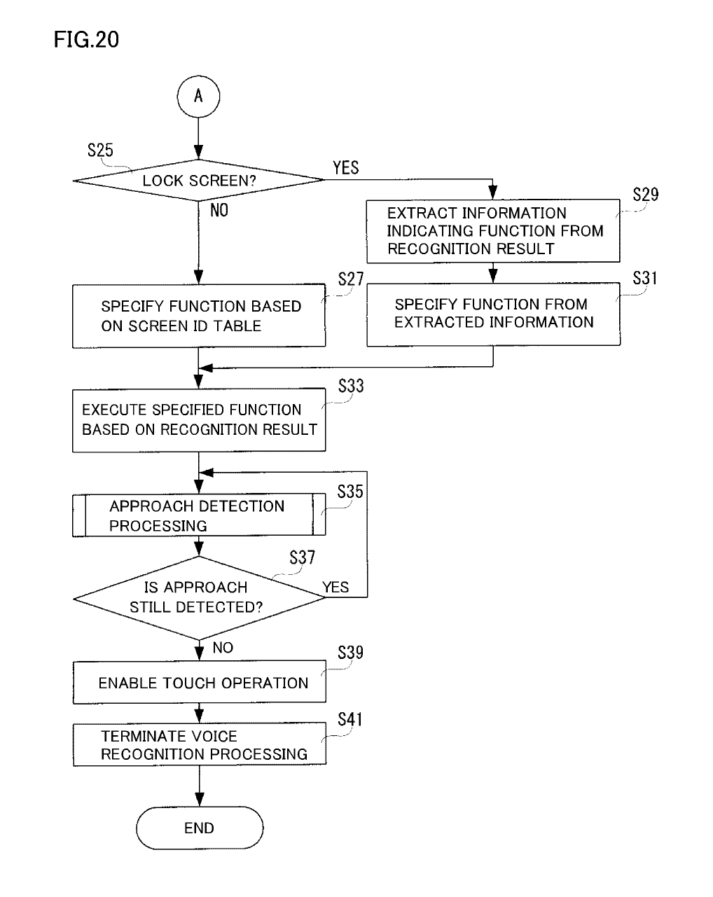

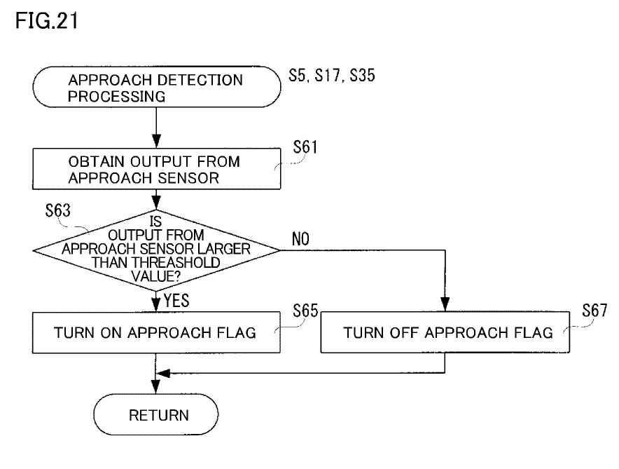

Processor 30 can process a plurality of tasks including the voice operation process shown in FIGS. 19 and 20, an approach detection process shown in FIG. 21 and the like in parallel with each other under controls by Linux (registered trademark)-base OS such as Android (registered trademark) and REX or other OSs.

The voice operation process may be executed when mobile phone 10 is turned on, for example. In step S1, processor 30 determines whether or not a predetermined screen has been displayed. That is, processor 30 can read a screen ID of a displayed screen stored in screen ID buffer 334, and can determine whether a function is stored in the column of function in association with the screen ID in screen ID table 342. If it is “NO” in step S1, that is, if the predetermined screen has not been displayed, the processing of step S1 is executed repeatedly.

If it is “YES” in step S1, for example, if the lock screen set as a predetermined screen is displayed, processor 30 can turn on proximity sensor 24 in step S3. That is, in order to detect approach of a target object with the predetermined screen being displayed, proximity sensor 24 is turned on. In step S5, processor 30 can execute approach detection processing. The approach detection processing will be described in detail using the flowchart of FIG. 21, and description thereof is omitted here. In step S7, processor 30 can determine whether or not approach has been detected. It may be determined whether approach flag 348 is on. Processor 30 executing the processing of step S7 may function as a determination module.

If it is “NO” in step S7, that is, if approach of a target object has not been detected, processor 30 returns the process to step S5. If it is “YES” in step S7, for example, if approach of the user's face has been detected, and approach flag 348 is on, processor 30 can display voice recognition icon SR in step S9. For example, as shown in FIG. 9, voice recognition icon SR may be displayed in status display region 60. In step S11, processor 30 can disable a touch operation. Touch disabling flag 346 is turned on. In step S13, processor 30 can execute voice recognition processing. The state where the voice recognition function has been executed is brought about. Processor 30 executing the processing of step S11 may function as a disabling module. Processor 30 executing the processing of step S13 may function as a voice recognition module.

In step S15, processor 30 can determine whether or not valid voice has been input. For example, processor 30 can determine whether the recognition result of voice recognition stored in recognition result buffer 338 indicates a number or function. If it is “NO” in step S15, for example, if voice has not been input or input voice is not valid, processor 30 can execute approach detection processing in step S17. In step S19, processor 30 can determine whether or not approach is still detected. That is, it is determined whether approach flag 348 is off.

If it is “NO” in step S19, for example, if the user's face is no longer detected, and approach flag 348 has been switched to off, processor 30 can enable a touch operation in step S21. That is, touch disabling flag 346 is turned off. In step S23, processor 30 can terminate the voice recognition processing. The voice recognition function is terminated. When the processing of step S23 is terminated, processor 30 returns the process to step S1.

If it is “YES” in step S19, for example, if the user's face remains detected, processor 30 returns the process to step S15. If it is “YES” in step S15, for example, if “call to AAA” has been input by voice, and such a recognition result has been stored in recognition result buffer 338, processor 30 can determine whether or not the lock screen is displayed in step S25. It is determined whether a screen ID stored in screen ID buffer 334 is in agreement with the screen ID of the lock screen.

If it is “NO” in step S25, for example, if the screen being displayed is the address screen, processor 30 can specify a function based on screen ID table 342 in step S27. For example, when the telephone number input screen is displayed, the telephone function is specified based on the column of function associated with the telephone number input screen in screen ID table 342. When the processing of step S27 is terminated, processor 30 advances the process to step S33.

If it is “YES” in step S25, for example, if the screen being displayed is the lock screen, processor 30 can extract information indicating a function from the recognition result in step S29. For example, if recognition result buffer 338 stores “call to AAA”, “call” is extracted as information indicating a function. In step S31, processor 30 can specify a function from the extracted information. For example, if “call” has been extracted, the telephone function is specified. When the processing of step S31 is terminated, processor 30 advances the process to step S33.

In step S33, processor 30 can execute the function specified based on the recognition result. For example, when the telephone function has been specified, if the character string included in the recognition result is a number, calling processing is executed using the number as a telephone number. If the character string included in the recognition result is not a number, it is searched whether the character string has been registered as the name of address data, and if relevant address data is found, the calling processing is executed based on the telephone number included in the address data. When the telephone function is executed in this way, processor 30 executing step S33 may function as a calling module.

If recognition result buffer 338 stores “a route to a XX station”, and if the map function screen is displayed, it is determined as “NO” in step S25. At this time, in step S27, the “map function” may be specified based on the screen ID stored in screen ID buffer 334 and screen ID table 342. Processor 30 executing the processing of step S27 may function as a first specifying module.

If recognition result buffer 338 stores “a route to a XX station”, and if the lock screen is displayed, it is determined as “YES” in step S25. At this time, in step S29, a “route” may be extracted from the recognition result as information indicating a function, and the “map function” may be specified in step S31 based on the “route.” Processor 30 executing the processing of step S29 may function as an extraction module, and processor 30 executing the processing of step S31 may function as a second specifying module.

When a function is specified in step S27 or step S31, in step S33, the map function is executed based on the “route” and the “XX station” included in the recognition result, and then a route from a current location to the “XX station” is searched. As a result, a screen as shown at (A) of FIG. 10 is displayed on display 14. Since functions other than the telephone function are executed in step S33, processor 30 executing the processing of step S33 may also be referred to as an execution module.

When the specified function is executed in step S33, processor 30 can execute approach detection processing in step S35, and can determine whether or not approach is still detected in step S37. If it is “YES” in step S37, for example, if the face of a user who is talking over the phone is detected, and if approach flag 348 is on, processor 30 returns the process to step S35. If it is “NO” in step S37, for example, if a call has been terminated, the user has moved his/her face away from mobile phone 10, and approach flag 348 is off, processor 30 enables a touch operation in step S39, and terminates the voice recognition processing in step S41. When the processing of step S41 is terminated, processor 30 can terminate the voice operation process.

If the function executed on a predetermined screen is the telephone function alone, the processing of steps S27 to S31 specifying a function may be omitted.

FIG. 21 is a flowchart of an approach detection process. For example, when the processing of step S5 is executed in the voice operation process shown in FIG. 19, processor 30 can obtain output from proximity sensor 24 in step S61. A value of proximity sensor 24 is read from approach buffer 332. In step S63, processor 30 can determine whether or not the value of proximity sensor 24 is larger than a threshold value. It is determined whether a target object detected by proximity sensor 24 has approached mobile phone 10. If it is “YES” in step S63, that is, if the distance between proximity sensor 24 and the target object is small, and if the value of proximity sensor 24 is larger than the threshold value, processor 30 can turn on approach flag 348 in step S67. It is determined that it is the state where approach of the target object has been detected. If it is “NO” in step S63, for example, if the distance between proximity sensor 24 and the target object is large, and if the value of proximity sensor 24 is smaller than the threshold value, processor 30 can turn off approach flag 348 in step S69. It is determined that it is the state where approach of the target object has not been detected.

When on/off of approach flag 348 is set, processor 30 can terminate the approach detection process.

The functions that can be executed by a voice operation on the lock screen may include a SMS function and the like.

Calling by the telephone function also includes calling by an Internet telephone function, such as “Skype (registered trademark)” and “LINE (registered trademark)”, as well as calling by an Internet phone function.

While the word “larger” is used for a threshold value for a predetermined number of times and the like in the above-described embodiment, the expression “larger than a threshold value” also includes the meaning of “larger than or equal to a threshold value.” The expression “smaller than a threshold value” also includes the meaning of “smaller than or equal to a threshold value” or “less than a threshold value.”

The program used in an embodiment may be stored in HDD of a data distribution server, and may be distributed to mobile phone 10 over a network. A storage medium, such as an optical disk including CD, DVD and BD (Blu-Ray Disk), a USB memory, and a memory card, having a plurality of programs stored thereon, may be sold or distributed. When a program downloaded through the above-mentioned server, the storage medium or the like is installed in a mobile terminal of a configuration equivalent to that of an embodiment, effects equivalent to those of an embodiment are acquired.

All of specific numerical values mentioned in the present specification are mere examples, and can be varied as appropriate depending on changes in product specification and the like.

A mobile phone according to a first embodiment is a mobile phone including a display module. The mobile phone comprises a detection module, and at least one processor. The detection module is configured to detect approach of a target object. The processor is configured to determine whether the detection module has detected approach of the target object when a predetermined screen is displayed on the display module. The processor is configured to, when it is determined that approach of the target object has been detected, recognize voice having been input while approach of the target object is detected. The processor is configured to, when a recognition result of the voice instructs calling, make a call based on the recognition result.

The mobile phone according to the first embodiment (10: reference character illustrating a corresponding portion in embodiments, which also applies hereinbelow) has a display module (14) such as LCD, organic electroluminescent display or the like. The detection module (24) can detect approach of a target object, such as the user's face, using infrared light, for example. When a predetermined screen is displayed, the processor (30, S7) can determine whether approach of the target object has been detected. When approach of the target object is detected with the predetermined screen being displayed, the processor (30, S13) can recognize voice having been input while approach of the target object is detected. When a recognition result of instructing calling is obtained while approach of the target object is being detected with the predetermined screen being displayed, the processor (30, S33) can make a call based on the recognition result.

According to the first embodiment, when a user brings his/her face closer to the mobile phone with the predetermined screen being displayed on the display module and instructs calling, a call can be made.

A second embodiment depends on the first embodiment, and when the recognition result includes a number, the processor can make a call using the number as a telephone number.

In the second embodiment, when voice is input with the telephone number input screen being displayed, for example, the processor can recognize the input voice. When the recognition result includes a number, the processor can make a call using the number as a telephone number.

A third embodiment depends on the first embodiment, and further comprises a memory module configured to store address data including a telephone number. When the recognition result indicates address data, the processor can make a call based on the address data.

In the third embodiment, the memory module (44) is a flash memory, for example, and is configured to store address book data containing a plurality of pieces of address data. Each piece of address data contains a partner's telephone number and the like. If voice is input when the predetermined screen is displayed, the processor can recognize the input voice. When the recognition result specifies stored address data, the processor can make a call to the telephone number included in the address data.

According to the third embodiment, a user can make a call only by inputting by voice a word or telephone number specifying registered address data.

A fourth embodiment depends on the first embodiment, and the predetermined screen includes a screen relevant to the telephone function.

In the fourth embodiment, the screen relevant to the telephone function includes the telephone number input screen, the address screen on which the above-described address book data is displayed, and the like, for example.

According to the fourth embodiment, if the screen relevant to the telephone function is displayed, a user can easily make a call.

A fifth embodiment depends on the first embodiment, and the predetermined screen includes a lock screen.

In the fifth embodiment, when voice is input while the lock screen is displayed, the processor can recognize the voice. When the address data stored is specified, the processor can make a call based on the address data.

According to the fifth embodiment, a user can make a call without canceling the locked state.

A sixth embodiment depends on the first embodiment, and further comprises a touch panel located on the display module. The processor is configured to, when it is determined that approach of the target object has been detected, disable an operation based on the touch panel.

In the sixth embodiment, the touch panel (16) is also called a pointing device and is located on the display module. The detection module is located around the touch panel. When approach of a target object is detected, the processor (30, S11) can disable an operation based on the touch panel.

According to the sixth embodiment, a malfunction that would be caused by approach of a face or the like to the touch panel can be prevented from occurring.

A seventh embodiment is a voice operation method in the mobile phone (10) having the display module (14) and the detection module (24) configured to detect approach of a target object. According to the voice operation method, the processor (30) of the mobile phone executes a determination step (S7), a voice recognition step (S13), and a calling step (S33). In the determination step (S7), it is determined whether the detection module has detected approach of the target object when a predetermined screen is displayed on the display module. In the voice recognition step (S13), when the determination step determines that approach of a target object has been detected, voice having been input while approach of the target object is detected is recognized. In the calling step (S33), when the recognition result of the voice recognition step instructs calling, a call is made based on the recognition result.

Also in the seventh embodiment, similarly to the first embodiment, when a user brings his/her face closer to the mobile phone with the predetermined screen being displayed on the display module and instructs calling, a call can be made.

An eighth embodiment is a mobile terminal including a display module. The mobile terminal comprises a detection module, and at least one processor. The detection module is configured to detect approach of a target object. The processor is configured to determine whether the detection module has detected approach of the target object when a predetermined screen is displayed on the display module. The processor is configured to, when it is determined that approach of the target object has been detected, recognize voice having been input while approach of the target object is detected. The processor is configured to, when a recognition result of the voice is valid, execute a function based on the recognition result.

In the eighth embodiment, the mobile terminal (10) including the display module (14) comprises the detection module (24), and the processor (30, S7, S13) similarly to the first embodiment. If a valid recognition result is obtained while approach of a target object is detected with the predetermined screen being displayed, the processor (30, S33) of the mobile terminal can execute a function based on the recognition result.

According to the eighth embodiment, a user can utilize a voice operation appropriately.

A ninth embodiment depends on the eighth embodiment, and further comprises a memory module. The memory module is configured to store functional information indicating a function corresponding to the predetermined screen. The processor is configured to specify the function based on the functional information stored in the memory module. The processor is configured to execute the function specified based on the recognition result.

In the ninth embodiment, functional information is associated with the predetermined screen, and this is stored in the memory module (46). The processor (30, S27) can specify a function corresponding to the predetermined screen based on the functional information. For example, if the specified function is the map function, and if the recognition result is an instruction of route search, the processor can execute the map function to perform route search.

According to the ninth embodiment, even in the state where some function is being executed, a user can operate the function by a voice operation.

A tenth embodiment depends on the eighth embodiment. The predetermined screen includes a lock screen. The processor is configured to, when approach of the target object is detected while the lock screen is displayed, extract information indicating a function from the recognition result. The processor is configured to specify the function based on the information extracted. The processor is configured to execute the function specified based on the recognition result.

In the tenth embodiment, if voice is input while the lock screen is displayed, the processor can recognize the input voice. The processor (30, S29) can extract information indicating a function (“route” etc.) from the recognition result obtained in this manner. The processor (30, S31) can specify a function to be executed based on the extracted information. For example, when the map function is specified and route search is instructed, the processor can execute the map function to perform route search.

According to the tenth embodiment, a user can execute any function by a voice operation without performing the operation of cancelling the lock screen.

Although the present disclosure has been described and illustrated in detail, it is clearly understood that the same is by way of illustration and example only and is not to be taken by way of limitation, the scope of the present disclosure being interpreted by the terms of the appended claims.

1. A mobile phone including a display module, comprising:
a detection module configured to detect approach of a target object; and
at least one processor,
the at least one processor is configured to
determine whether the detection module has detected approach of the target object while a predetermined screen is displayed on the display module,
when it is determined that approach of the target object has been detected, recognize voice having been input while approach of the target object is detected, and
when a recognition result of the voice instructs calling, make a call based on the recognition result.

2. The mobile phone according to claim 1, wherein the at least one processor is configured to, when the recognition result includes a number, make a call using the number as a telephone number.

3. The mobile phone according to claim 1, further comprising a memory module configured to store address data including a telephone number, wherein
the at least one processor is configured to, when the recognition result indicates address data, make a call based on the address data.

4. The mobile phone according to claim 1, wherein the predetermined screen includes a screen relevant to a telephone function.

5. The mobile phone according to claim 1, wherein the predetermined screen includes a lock screen.

6. The mobile phone according to claim 1, further comprising:
a touch panel located on the display module, wherein
the at least one processor is configured to, when it is determined that approach of the target object has been detected, disable an operation based on the touch panel.

7. A voice operation method in a mobile phone including a display module and a detection module configured to detect approach of a target object, comprising:
determining whether the detection module has detected approach of the target object while a predetermined screen is displayed on the display module;
when the determination step determines that approach of the target object has been detected, recognizing voice having been input while approach of the target object is detected; and
when a recognition result of the voice recognition step instructs calling, making a call based on the recognition result.

8. A mobile terminal including a display module, comprising:
a detection module configured to detect approach of a target object; and
at least one processor,
the at least one processor is configured to
determine whether the detection module has detected approach of the target object while a predetermined screen is displayed on the display module,
when it is determined that approach of the target object has been detected, recognize voice having been input while approach of the target object is detected, and
when a recognition result of the voice is valid, execute a function based on the recognition result.

9. The mobile terminal according to claim 8, further comprising:
a memory module configured to store functional information indicating a function corresponding to the predetermined screen, wherein
the at least one processor is configured to
specify the function based on the functional information stored in the memory module, and
execute the function specified based on the recognition result.

10. The mobile terminal according to claim 8, wherein
the predetermined screen includes a lock screen,
the at least one processor is configured to
when approach of the target object is detected while the lock screen is displayed, extract information indicating a function from the recognition result,
specify the function based on the information extracted, and
execute the function specified based on the recognition result.
